(19) United States
(12) Patent Application Publication
(10) Pub. No.: US 2014/0090281 A1
(43) Pub. Date: Apr. 3, 2014

(54) ADVERTISING DEVICE

(71) Applicant: Henry Jansen, Bloemfontein (ZA)

(72) Inventor: Henry Jansen, Bloemfontein (ZA)

(73) Assignee: KINETIC BANNER SA (PTY) LTD, Bloemfontein (ZA)

(21) Appl. No.: 14/118,395

(22) PCT Filed: May 17, 2012
(86) PCT No.: PCT/ZA2012/000035

§ 371 Date: Nov. 18, 2013

(30) Foreign Application Priority Data
May 17, 2011 (ZA) 2011/3661

(51) Int. Cl. G09F 19/02; G09F 19/22

(52) U.S. Cl. CPC G09F 19/02; G09F 19/22
USPC 40/584; 40/541

(57) ABSTRACT

The invention provides a device for advertising (10), which device includes a post (12), which post (12) is configured to have attached thereto a plurality of slats (18) extending horizontally away from the post (12) and in a vertical plane along the post (12) with each slat (18) being pivotably dependable from a horizontal axis (20) to depend in the vertical plane when no wind is present and to be pivoted out of the plane by wind. One embodiment shows a support structure for slats (18) in the form of a frame (30). The device (10) further includes LED lighting strips (32) to illuminate the slats (18), in use, during the night. The device (10) further includes a platform (34) provided with solar panels (36) and chargeable electrical power storage means within the post (12).

### TECHNICAL FIELD OF THE INVENTION

This invention relates to a device for advertising or displaying printed matter.

### BACKGROUND TO THE INVENTION

The inventor is aware of the use of lamp posts for attaching flags and small bill boards. However, the inventor believes that most lamp posts provide a large advertising space defined in the triangular area between the vertical post and the usually horizontal arm extending to the lamp.

It is an object of the invention to make use of this advertising space and to provide a post or device for advertising.

### GENERAL DESCRIPTION OF THE INVENTION

According to the invention there is provided a device for advertising, which device includes:

a post; and the post is configured to have attached thereto a plurality of slats extending horizontally away from the post and in a vertical plane along the post with each slat being pivotably dependable from a horizontal axis to depend in the vertical plane when no wind is present and to be pivoted out of the plane by wind.

The invention extends to a plurality of slats or a set of slats for use with a device for advertising as described above.

It will be appreciated that the invention is a device for advertising, not an advertising device, and that it is not the intention of the inventor to include the slats for the invention to be functional since the slats and the post can be manufactured and sold separately.

The slats may be dimensioned to generally fill the plane, in side view, to provide a generally uniform surface for printed matter such as an advertisement.

It will be appreciated that the pivotable, or swinging, slats will allow wind to flow through the slats, in a louver fashion, and that the uniform surface will be broken by wind and return when the wind stops to provide a dynamic visual effect.

The lower edge of the slat may be narrower, in cross section, than the upper edge of the slat below it to increase the visual effect of a uniform and solid surface when viewed at an angle from below even when the slats pivot to a limited extent. In other words, the slats may taper, in cross section, from the upper horizontal edge to the lower horizontal edge.

The device for advertising may include horizontal beams, braces or other support structures extending from the post to support or frame the slats.

The device for advertising may be provided with lighting to illuminate the slats, in use, during the night.

The device for advertising may be provided with solar panels and chargeable power storage means such as an electrical battery or electrical cell to power the lighting.

The post may be a lamp past or post of a street light with the horizontal beam extending towards a light fitting at its free end.

The horizontal beam, or part thereof, may extend in opposite directions from the post, to form a T-bar. The invention therefore provides for both one and two sided lamp posts or street lights.

The post and/or beam may be diamond shaped in cross-section.

The slats may preferably be detachable. It will be appreciated that if the printed matter is placed on the slats prior to being attached to the device, installation time in the field will be reduced and new printed matter can be installed by replacing the slats. The detached slats can be cleaned and re-used.

The device may be retrofitted to existing lamp posts or street lights. Alternatively, a lamp post or street light may be manufactured integrally with the device.

It will be appreciated that the device, in accordance with the invention may be manufactured in many shapes, designs and configurations.

The invention also extends to a method of advertising, which method includes the step of printing matter in sequence on a set of slats for a device as described above and installing the slats.

### DETAILED DESCRIPTION OF THE INVENTION

The invention is now described by way of example with reference to the accompanying drawings.

In the drawings:

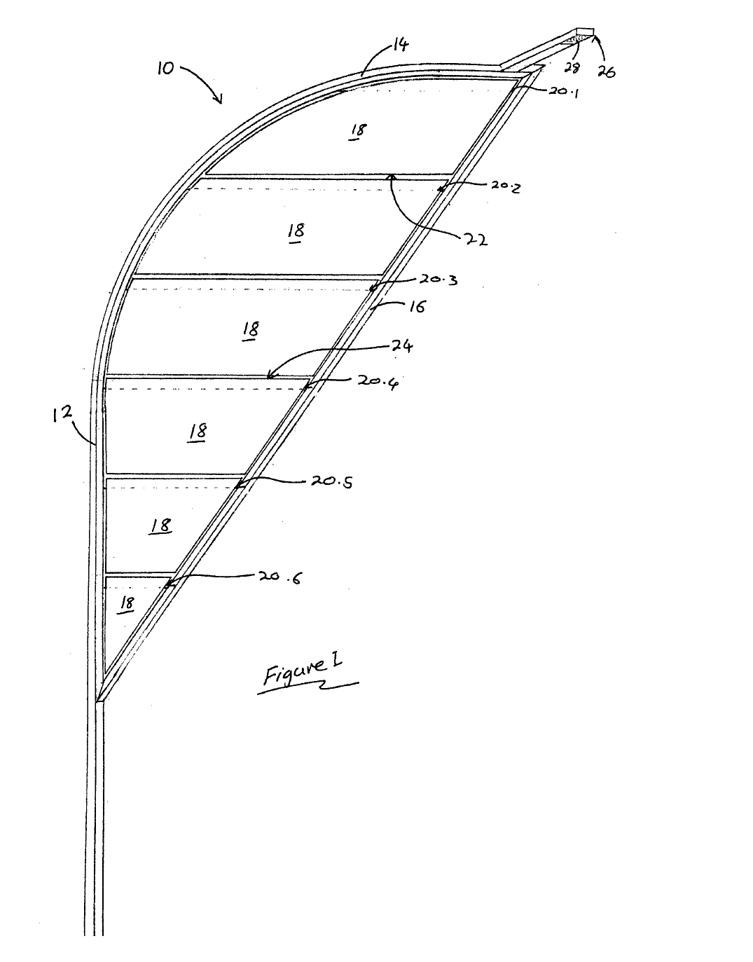

FIG. 1 shows a side view of a device for advertising, in accordance with the invention;

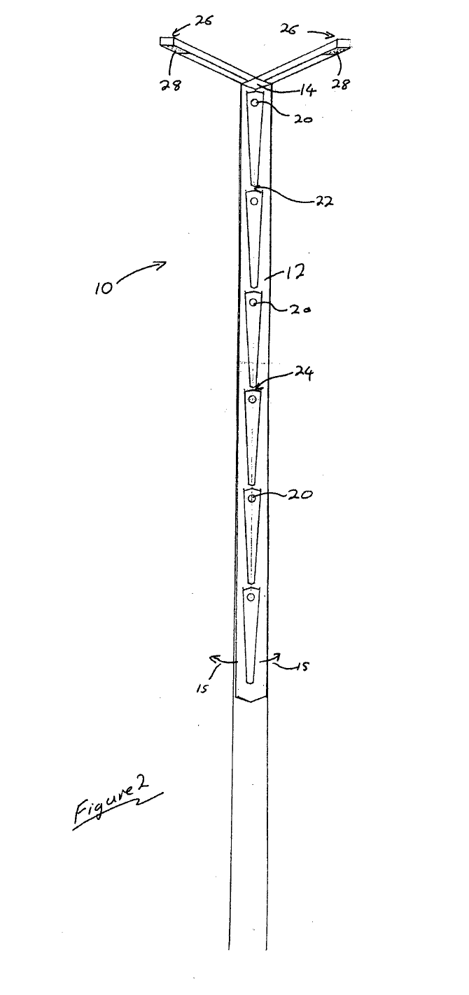

FIG. 2 shows an end view of the device with the support brace removed to show end view details of the slats;

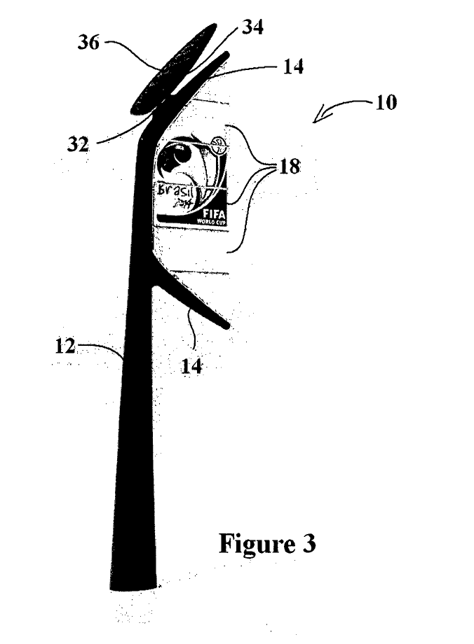

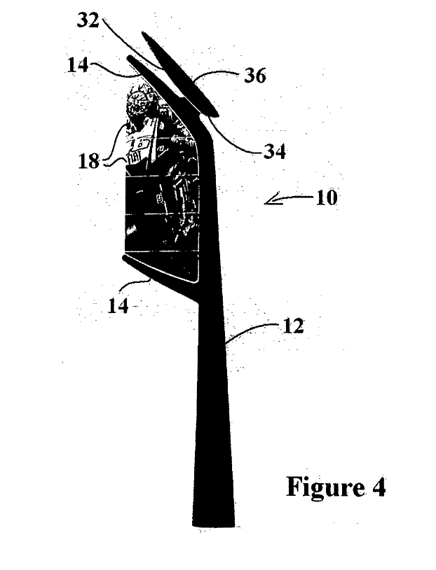

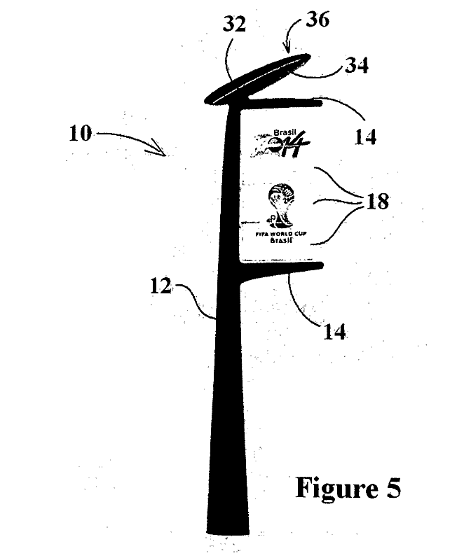

FIGS. 3 to 5 shows side perspective views of further embodiments of the device for advertising, in accordance with the invention; and

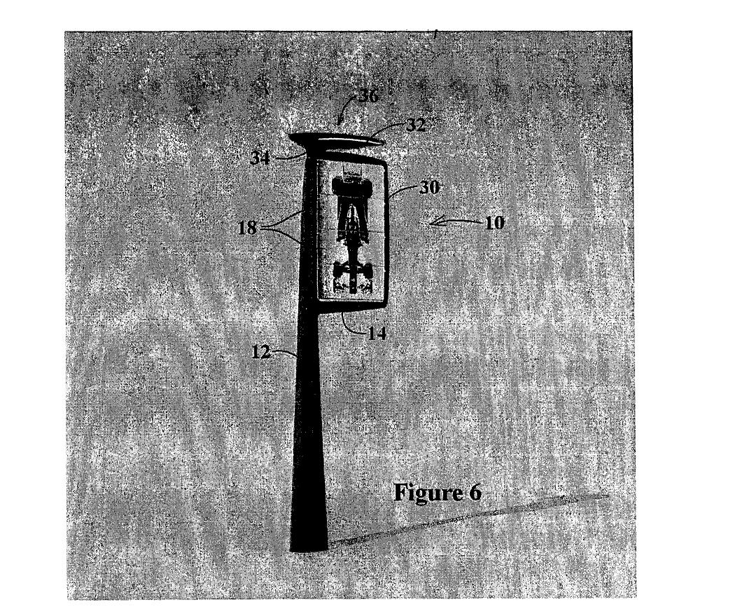

FIG. 6 shows side perspective view of a further embodiment of the device for advertising, in accordance with the invention.

Referring now to FIGS. 1 and 2, the device for advertising, in accordance with the invention, is generally indicated by reference numeral 10. The device is in the form of a street light and includes an upright post 12; a generally horizontal beam 14 extending from the upright post, and a brace 16 extending diagonally from a lower part of the post to the beam proximate its free end. The beam, post and brace define a generally triangular plane in the vertical between them. The device 10 further includes six detachable slats 18 in the plane defined by the triangular shape with each slat being pivotably (see arrows 15) dependable from a horizontal axis 20 to depend in the vertical plane when no wind is present and to be pivoted out of the plane by wind. The slats 18 are dimensioned to generally fill the triangular plane, in side view, to provide a generally uniform surface for printed matter such as an advertisement. The lower edge 22 of the slat may be narrower, in cross section, than the upper edge 24 of the slat below it to increase the visual effect of a uniform and solid surface when viewed at an angle from below even when the slats pivot to a limited extent. The horizontal beam 14 is curved and extends uniformly from the post 12. Opposed ends 26 of the horizontal beam extend in opposite directions towards respective light fittings 28. The post 12, beam 14 and brace 16 are diamond shaped in cross-section.

Referring now to FIGS. 3 to 6, the device for advertising, in accordance with the invention, is generally indicated by reference numeral 10. The device 10 includes an upright post 12, and a pair of generally horizontal beams 14 extending from the upright post, which is configured to have attached thereto a plurality of detachable slats 18 extending horizontally away from the post and in a vertical plane along the post with each slat being pivotably dependable from a horizontal axis to depend in the vertical plane when no wind is present and to be pivoted out of the plane by wind. The slats 18 are dimensioned to generally fill the plane, in side view, to provide a generally uniform surface for printed matter such as an advertisement. The embodiment shown in FIG. 6 shows the support structure for slats 18 in the form of a frame 30. The device 10 further includes LED lighting strips 32 to illuminate the slats, in use, during the night. The device 10 further includes a platform 34 be provided with solar panels 36 and chargeable electrical power storage means within the post 12. The upright post is constructed from of a composite material.

It shall be understood that the examples are provided for illustrating the invention further and to assist a person skilled in the art with understanding the invention and are not meant to be construed as unduly limiting the reasonable scope of the invention.

1. A device for advertising, which device includes:
a post; and the post is configured to have attached thereto a plurality of slats extending horizontally away from the post and in a vertical plane along the post with each slat being pivotably dependable from a horizontal axis to depend in the vertical plane when no wind is present and to be pivoted out of the plane by wind.

2. A device as claimed in claim 1, which includes a plurality of slats extending horizontally away from the post and in a vertical plane along the post with each slat being pivotably dependable from a horizontal axis to depend in the vertical plane when no wind is present and to be pivoted out of the plane by wind.

3. A device as claimed in claim 1, wherein the slats are dimensioned to generally fill the plane, in side view, to provide a generally uniform surface for printed matter such as an advertisement.

4. A device as claimed in claim 3, wherein the lower edge of the slat is narrower, in cross section, than the upper edge of the slat below it.

5. A device as claimed in claim 1, which includes any of horizontal beams, braces or other support structures extending from the post to support or frame the slats.

6. A device as claimed in claim 1, which includes lighting to illuminate the slats, in use, during the night.

7. A device as claimed in claim 6, which includes a solar panel and chargeable electrical power storage means to power the lighting.

8. A device as claimed in claim 1, wherein the device is configured such that the slats are detachable.

9. A set of slats for a device for advertising as claimed in claim 1.

10. A method of advertising, which method includes the step of printing matter in sequence on a set of slats for a device as claimed in claim 1.
